(19) United States
(12) Patent Application Publication
(10) Pub. No.: US 2019/0315229 A1
(43) Pub. Date: Oct. 17, 2019

(54) Operating Device For Selecting At Least One Gear Speed Of A Vehicle, Vehicle With An Operating Device And Method For Operating An Operating Device

(71) Applicant: ZF FRIEDRICHSHAFEN AG, Friedrichshafen (DE)

(72) Inventors: Lenard PETRZIK, Osnabrück (DE); Vitali FRIBUS, Quakenbrück (DE)

(73) Assignee: ZF FRIEDRICHSHAFEN AG, Friedrichshafen (DE)

(21) Appl. No.: 16/468,635

(22) PCT Filed: Nov. 15, 2017
(86) PCT No.: PCT/EP2017/079255

§ 371 Date: Jun. 11, 2019

(30) Foreign Application Priority Data
Dec. 13, 2016 (DE) 10 2016 224 838.3

(51) Int. Cl. B60K 35/00; B60K 20/08; B60K 37/06; F16H 59/08; F16H 61/24; G06F 3/01; G06F 3/0488

(52) U.S. Cl. CPC B60K 35/00; F16H 2306/40; B60K 37/06; F16H 59/08; F16H 61/24; G06F 3/016; G06F 3/017; G06F 3/0488; B60K 2370/1446; B60K 2370/1472; B60K 2370/158; B60K 2370/193; B60W 2710/10; B60Y 2400/902; F16H 2061/241; B60K 20/08

(57) ABSTRACT

The present approach to the problem addressed by the invention relates to an operating device (100) for selecting at least one gear setting of a vehicle. The operating device (100) has at least one sensor (105) that has at least one touch-sensitive region and a deformable surface (110), which is configured to form at least one haptic operating element with the sensor (105) in a deformed state (115). The haptic operating element (120) is configured to output a selection signal for selecting the gear setting in response to touching the touch-sensitive region.

The present approach to the problem addressed by the invention relates to an operating device for selecting at least one gear setting of a vehicle, a vehicle that has an operating device, and a method for operating an operating device.

In the framework of automating vehicles, an integration of operating elements that are not permanently accessible is necessary. These should be designed such that they can be operated as intuitively as possible.

Based on this, the present approach results in an improved operating device for selecting at least one gear setting of a vehicle, a vehicle that has an improved operating device, and a method for operating an improved operating device according to the independent claims. Advantageous embodiments can be derived from the dependent claims and the following description.

An operating device for selecting at least one gear setting of a vehicle has at least one sensor with a touch-sensitive region, and a deformable surface, which is configured to form at least one haptic operating element with the at least one sensor when it is in a deformed state. The sensor can be a touch sensor. The haptic operating element is configured to provide a selection signal for selecting a gear setting in response to touch. An operating device presented herein allows a user or driver of a vehicle to set a gear setting hapticly, merely by touching the touch-sensitive region. This results in an intuitive operating possibility for the driver this is not distracting. The operating device presented herein is of particular advantage for partially and/or highly automated vehicles, because it only forms an operating element for selecting the gear setting in the deformed state, and otherwise, e.g. during a highly automated driving mode of the vehicle, remains discreetly in the background when it is not in a deformed state. A highly automated driving mode can be an operating mode of the vehicle in which the vehicle is driven on a street or road at least partially without interaction or control by the driver of the vehicle. The operating element is accordingly only needed when the driver desires to switch to a manual driving mode in which the vehicle is at least partially controlled manually by the driver.

When the surface forms a haptic operating element in the deformed state, which has at least one raised section and/or a recess, it can enable a haptic guidance of a finger of the driver. The surface can advantageously form a haptic operating element in the deformed state, which forms at least one track for a finger. The driver can simply follow the finger track in order to set the gear setting. In order to be able to select different gear settings such as P, R, N, D, S, the operating element can also form numerous finger tracks, which can run in different directions, for example, and each of which is dedicated to a different gear setting. To enable a three dimensional deformation of the surface, the material of the surface can at least partially contain a polygonal and/or hexagonal structure.

The operating device can have at least one actuator according to an advantageous embodiment, which is configured to convert the surface to the deformed state and/or back to the un-deformed state. The actuator can be configured to deform the surface independently of whether or not a person touches the operating device. According to one embodiment, the actuator has an interface for receiving an electric actuation signal, which is able to control the actuator such that the surface is deformed.

According to various embodiments, the actuator can have at least a magnetorheological elastomer, and/or an electromagnetic actuator, and/or a pneumatic actuator, an electromagnetic actuator. The actuators presented herein can be used for a quick and technologically simple conversion to the deformed and/or un-deformed state of the surface.

When the touch-sensitive region contains at least one display section, which is configured to display at least the gear setting, the driver can visually check whether the gear setting that is to be set corresponds to the desired gear setting. The display section can contain at least an LCD-/TFT display and/or an OLED display, and/or an RP* polycarbonate film, which can reliably display the gear setting. The entire touch-sensitive region can also form a display region, wherein the gear settings that are to be set, e.g. P, R, N, D, S, can only be displayed, for example, in the display sections of the display region.

The surface can be at least partially formed by an elastomer, and/or wood, and/or metal, and/or rock, and/or synthetic material, and/or leather. These materials allow for three dimensional deformation of the surface.

It is also advantageous when at least a sub-region of the region of the operating device is configured according to an advantageous embodiment to generate haptic feedback in response to a touch. In this manner, a tangible confirmation can be given to the driver during a shifting process and/or in response to the gear setting that has been set. The haptic feedback can be implemented, for example, through at least one electrostatic film and/or at least one piezo actuator, which can be located in the sub-region, e.g. in the display section of the region.

The operating device is or can be located in an armrest and/or a hand rest, and/or a central console, and/or a steering wheel, and/or a dashboard of the vehicle. The installation locations specified here can be quickly and intuitively accessed by the driver.

In order to then only convert the surface to the deformed state when the operating element is needed, it is advantageous when the surface is converted to the deformed state in response to a starting of the vehicle, and/or a proximity signal from a proximity sensor system of the vehicle, when the operating device is located in the vehicle. The proximity signal can represent the proximity of a hand of the driver to the operating device. The proximity signal can also represent the proximity of the driver to the vehicle.

A vehicle has one of the operating devices described above. The vehicle presented herein can implement the advantages of the operating device described above.

A method for operating any of the operating devices described above comprises at least the following steps:

inputting a touch signal, which represents a touching of the touch-sensitive region of the haptic operating element; and

outputting a gear signal that is configured to set the gear setting through on the basis of the touch signal.

This method can be implemented in a control device in the form of software or hardware, or in a mixture of software and hardware, for example. The advantages of the operating device described above can also be implemented in a technologically simple and inexpensive manner by such a method.

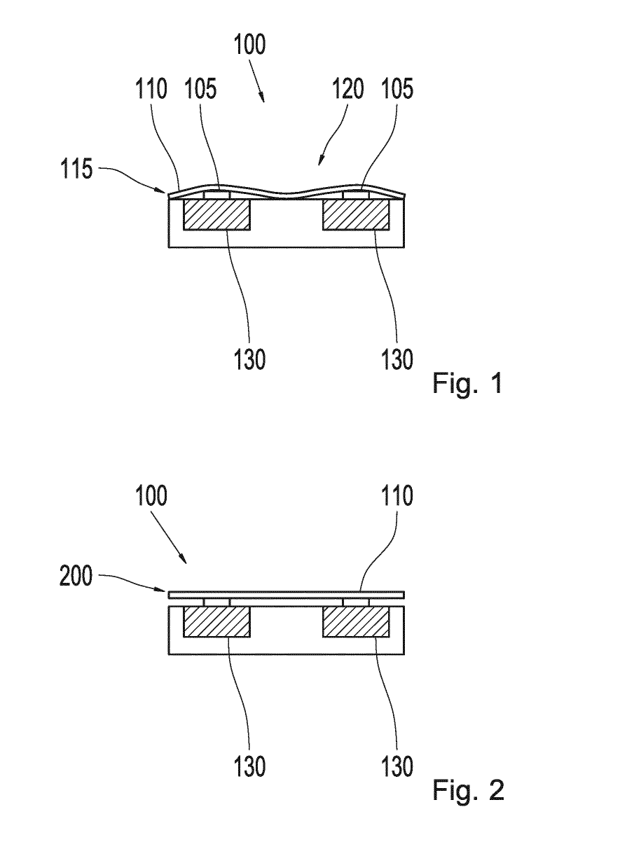

FIG. 1 shows a schematic cross sectional illustration of an operating device for selecting at least one gear setting of a vehicle according to an exemplary embodiment;

FIG. 2 shows a schematic cross sectional illustration of an operating device according to an exemplary embodiment;

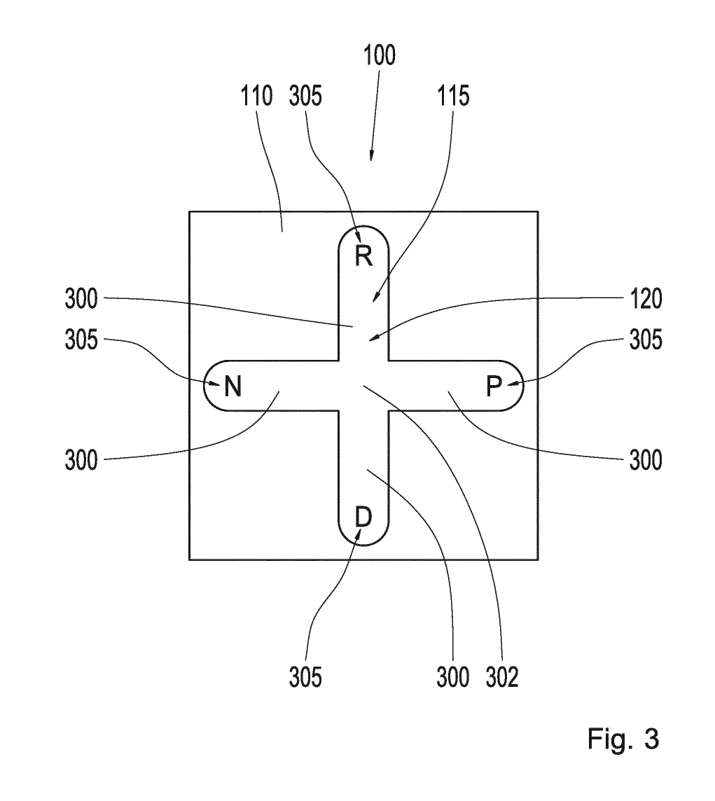

FIG. 3 shows a schematic top view of an operating device according to an exemplary embodiment;

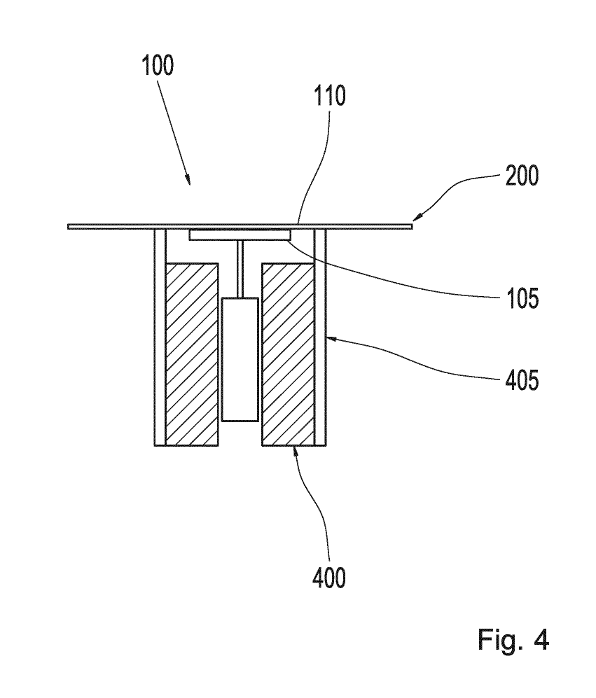

FIG. 4 shows a schematic cross sectional illustration of an operating device according to an exemplary embodiment;

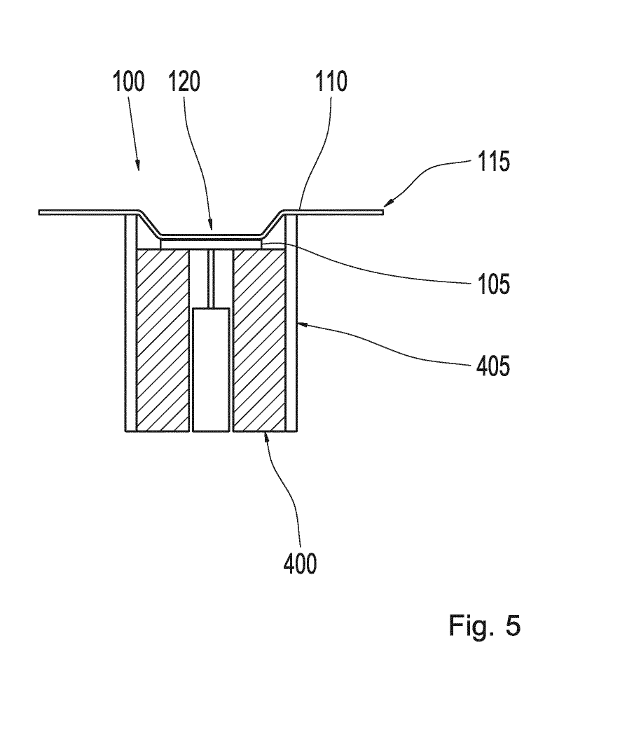

FIG. 5 shows a schematic cross sectional view of an operating device according to an exemplary embodiment;

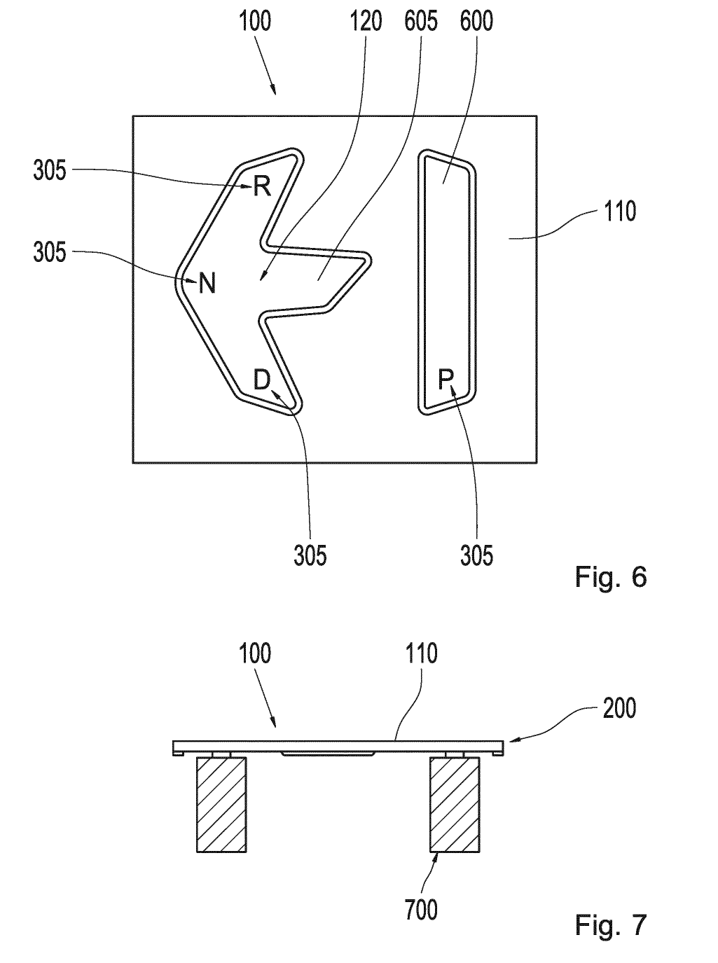

FIG. 6 shows a schematic top view of an operating device according to an exemplary embodiment;

FIG. 7 shows a schematic cross sectional illustration of an operating device according to an exemplary embodiment;

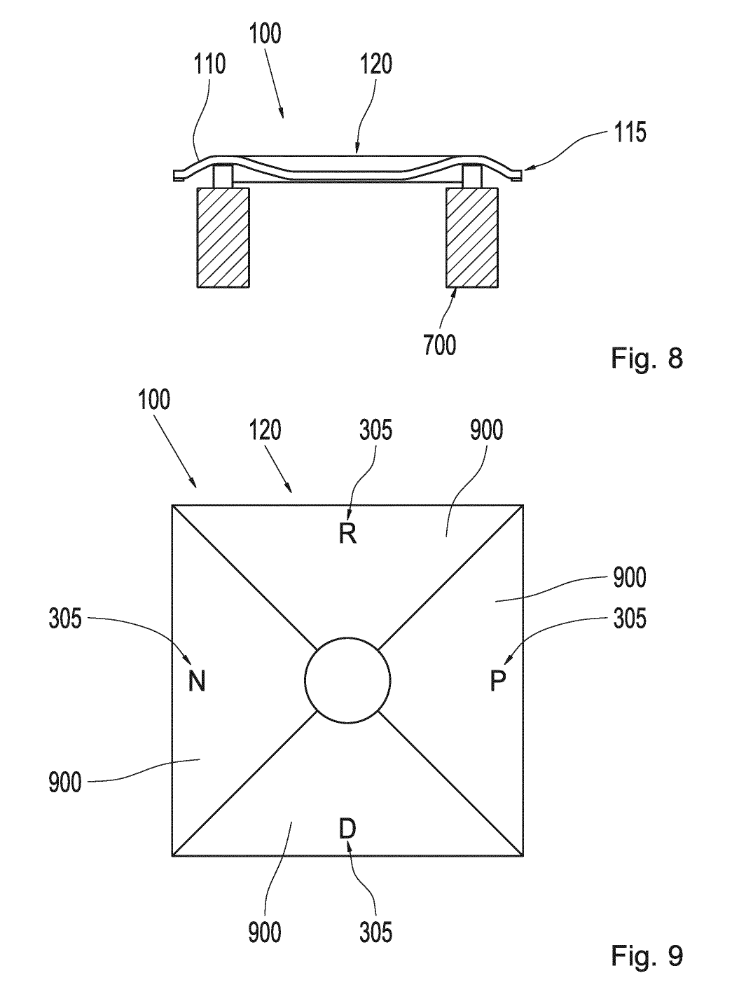

FIG. 8 shows a schematic cross sectional illustration of an operating device according to an exemplary embodiment;

FIG. 9 shows a schematic top view of an operating device according to an exemplary embodiment;

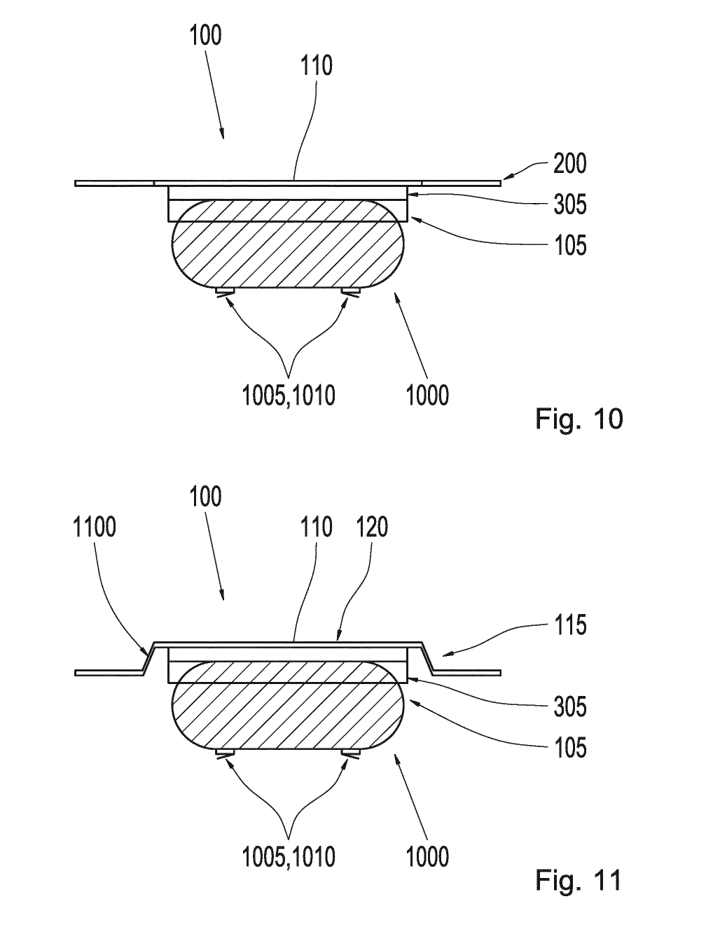

FIG. 10 shows a schematic cross sectional illustration of an operating device according to an exemplary embodiment;

FIG. 11 shows a schematic cross sectional illustration of an operating device according to an exemplary embodiment;

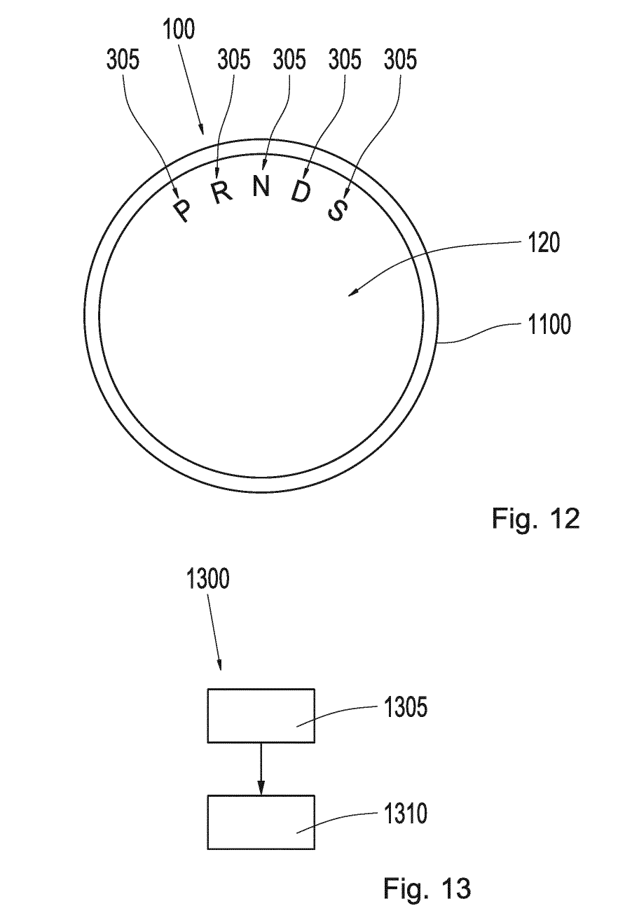

FIG. 12 shows a schematic top view of an operating device according to an exemplary embodiment; and

FIG. 13 shows a flow chart for a method for selecting at least one gear setting of a vehicle according to an exemplary embodiment.

In the following description of preferred exemplary embodiments of the present approach, identical or similar reference symbols shall be used for the elements depicted in the various figures that have similar functions, wherein the descriptions of these elements shall not be repeated.

FIG. 1 shows a schematic cross sectional illustration of an operating device 100 for selecting at least one gear setting of a vehicle according to an exemplary embodiment. The operating device 100 is configured to at least set the gear setting of the vehicle. The operating device 100 has at least one sensor 105 and one deformable surface 110 for this. According to this exemplary embodiment, the operating device 100 has four sensors 105, two of which sensors 105 can be seen in the cross section shown herein. The deformable surface 110 is configured to form at least one haptic operating element 120 with the sensors 105 that has at least one touch-sensitive region when it is in the deformed state 115. The surface 110 is shown in the deformed state 115 in FIG. 1, in which the haptic operating element 120 exhibits a recess according to this exemplary embodiment.

According to various exemplary embodiments, the sensor(s) 105 can be integrated in the surface 110 or located on the surface 110. The surface 110 can be formed as a deformable layer, e.g. a film or suchlike.

According to one exemplary embodiment, each of the sensors 105 has a dedicated touch-sensitive region, or a touch-sensitive region is formed by each sensor 105. The haptic operating element 120 is configured to output a selection signal indicating the actuation of the operating device 100 in response to touching the haptic operating element 120 in or on the touch-sensitive region or one of the touch-sensitive regions. The selection signal can be an electric signal that is received by a transmission control device and used for setting a gear setting to which one of the touch-sensitive regions that has been touched is dedicated.

The operating device 100 has at least one actuator 130, four actuators 130 according to this exemplary embodiment, two of which actuators 130 are visible in the cross section. The actuators are configured to convert the surface 110 to the deformed state 115. According to this exemplary embodiment, the actuators 130 are low-voltage actuators with a high level of expansion. The surface 110 is made of a magnetorheological material according to this exemplary embodiment. According to this exemplary embodiment, each of the actuators 130 can be actuated separately, or the actuators 130 can be actuated collectively, in order to deform the surface 110. For this, the actuators 130 are configured to each receive an electric actuation signal according to an exemplary embodiment.

The present approach describes an operating device 100 that generates at least one haptic operating element 120 or numerous haptic operating elements 120 for selecting a gear setting in closed surfaces 110. The operating device 100 can accordingly also be referred to as a device for generating haptic operating elements 120 in closed surfaces for selecting gear settings of a vehicle, or as a 3D-tronic. The operating device 100 presented herein is based on the fundamental principle that the surface 110 is deformed three dimensionally, thus generating the operating element 120 in the form of a finger track according to this exemplary embodiment, on which a user can orient in a tactile manner using the receptors of the human hand, in order to thus enable a guided, blind operation of the operating element 120. The haptic operating element 120 depicted herein has a touch-sensitive region, which either forms a display region on the whole, or comprises individual display sections, as is the case in the following exemplary embodiments shown in FIGS. 3, 6, 9 and 12. The region also contains the respective circuit diagram for the transmission settings, by means of which the driver can select the possible gear settings, also referred to as drive positions, by means of finger movement. The haptic operating element 120 according to this exemplary embodiment also contains recesses and/or, as shown in FIGS. 7 to 12, raised sections that form a haptic guide for the finger, providing the user, who can also be referred to as the driver or operator, with an intuitive and non-distracting operation by means of tactile perception.

The haptic operating element 120 can be formed using various technologies, and according to this exemplary embodiment, the surface 110 contains magnetorheological elements, wherein this material becomes deformed in a magnetic field, and returns to its initial shape after the magnetic field is switched off.

A quality of the surface 110 can be obtained using various materials, patterns and structures, which enable a three dimensional deformation, e.g. plastics with elastic properties such as elastomers, and/or wood, and/or metals, and/or rock, and/or substances such as synthetic substances, and/or leather. The structure of the surface 110 can be polygonal and/or hexagonal.

The haptic operating elements 120 can be formed or received in different surfaces 110 in the vehicle, e.g. armrests, hand rests, a central console, a steering wheel, and/or a dashboard of the vehicle. A setting of the haptic operating element 120, i.e. the converting of the surface 110 to the deformed state 115, can be initiated and deactivated with different processes, i.e. when the vehicle is started, or by means of a proximity sensor system.

FIG. 2 shows a schematic cross sectional illustration of an operating device 100 according to an exemplary embodiment. This can be the operating device 100 described in reference to FIG. 1, with the difference that the deformable surface 110 according to this exemplary embodiment is in a non-deformed state 200, in which the user of the operating device 100 does not have access to a haptic operating element for selecting the gear setting. According to an exemplary embodiment, the sensors of the operating device 100 are deactivated in this state. According to one exemplary embodiment, the sensors are activated in response to an activation of the actuators 130 for converting the surface 110 to the deformed state, and deactivated in response to a renewed activation of the actuators 130 or a deactivation of the actuators 130 for converting the surface 110 to the deformed state 200. Alternatively, the sensors can be active independently of the state of the surface 110, and thus independently of a state of the actuators 130.

FIG. 3 shows a schematic top view of an operating device 100 according to an exemplary embodiment. This can be the operating device 100 described in reference to FIG. 1, in which the surface 110 is in the deformed state 115. It can be seen in FIG. 3 that the surface 110 forms at least one haptic operating element 120, which forms four finger tracks 300 according to this exemplary embodiment, which cross one another when seen from above, and which are connected to one another in this exemplary embodiment at the deep centers 302 of the intersections. A base of the intersection visible herein forms the touch-sensitive region according to this exemplary embodiment. Each of the finger tracks 300 has a free end facing away from the middle 302, each of which contains a display section 305 according to this exemplary embodiment, which is configured to display one of the respective gear settings, P, R, N, D, to which it is dedicated. The sensors described in reference to FIG. 1, each of which is dedicated to one of the gear settings, P, R, N, D, are each located in the regions of the four display sections 305 according to this exemplary embodiment.

The touch-sensitive region can be obtained with various technologies, and according to this exemplary embodiment at least two of the display sections 305 comprise LCD/TFT displays with touch-sensitive sensor systems, also referred to as touchscreens. According to an alternative exemplary embodiment, the display sections 305 comprise OLED displays with touch-sensitive sensor systems, which are fused together in a “film-insert molded electronics” process to form a plastic component. According to another alternative exemplary embodiment, the display sections 305 comprise RP* polycarbonate films with touch-sensitive sensor systems integrated therein, or placed thereon, and a projector, which is located behind the visible surface 110, and projects the operating surface onto the visible surface 110, also referred to as back-projection. According to an alternative exemplary embodiment, the entire touch-sensitive region forms the display section 305. The touch-sensitive display sections 305 of the operating elements 120 are equipped with haptic feedback by means of various technologies, such as an electrostatic film or a solution based on piezo actuators, according to this exemplary embodiment, in order to make targeted individual regions of the operating surface, such as the shifting surface and the actuation field “perceivable.”

FIG. 4 shows a schematic cross sectional illustration of an operating device 100 according to an exemplary embodiment. This can be the operating device 100 described in reference to FIG. 2, with the difference that the operating device 100 has only one sensor 105, located beneath the middle of the surface 110, and that the actuators are formed by at least one electromagnetic actuator 400. The electromagnetic actuator 400 and the sensor 105 are received in a molded support 405 according to this exemplary embodiment.

FIG. 5 shows a schematic cross sectional illustration of an operating device 100 according to an exemplary embodiment. This can be the operating device 100 described in reference to FIG. 4, with the difference that the deformable surface 100 according to this exemplary embodiment is in the deformed state 115. The electromagnetic actuator 400 draws the material of the surface 110 toward it, and thus forms the recesses in the surface 110, or raised sections according to an alternative exemplary embodiment.

FIG. 6 shows a schematic top view of an operating device 100 according to an exemplary embodiment. This can be the operating device 100 described in reference to FIG. 5. The surface 110 is deformed according to this exemplary embodiment, such that in addition to the operating element 120, a further operating element 600 is also formed. The one operating element 120 is in the shape of an arrow according to this exemplary embodiment, and the other operating element 600 is in the shape of a straight line. A shaft 605 of the arrow-shaped operating element 120 runs transverse to a main extension of the straight other operating element 600. The visible bases of the operating elements 120, 600 form the touch-sensitive regions according to this exemplary embodiment. A tip of the arrow-shaped operating element 120 and two lateral ends of the tip of the arrow-shaped operating element 120, and an end of the other operating element 600 each have a display section 305 according to this exemplary embodiment, which is configured to display a respective gear setting P, R, N, D to which it is dedicated. According to this exemplary embodiment, the display section 305 dedicated to the gear setting P is located in the region of the other operating element 600, wherein the display sections 305 dedicated to the gear settings R, N, D are located in the region of the operating element 120. The sensor described in reference to FIG. 4 has at least four sensor elements according to this exemplary embodiment, each of which is dedicated to one of the gear settings, P, R, N, D. The sensor elements are located in the region of the four display sections 305 according to this exemplary embodiment.

FIG. 7 shows a schematic cross sectional illustration of an operating device 100 according to an exemplary embodiment. This can be the operating device 100 described in reference to FIG. 4, with the difference that the actuator is an electromechanical actuator 700.

FIG. 8 shows a schematic cross sectional illustration of an operating device 100 according to an exemplary embodiment. This can be the operating device 100 described in reference to FIG. 7, with the difference that the deformable surface 100 according to this exemplary embodiment is in the deformed state 115, in which the operating element 120 according to this exemplary embodiment forms a haptic finger guide. According to this exemplary embodiment, the electromechanical actuator 700 moves the surface 110 upward when converting the surface 110 to the deformed state 115, in contrast to the recesses formed in FIG. 1 or 5.

FIG. 9 shows a schematic top view of an operating device 100 according to an exemplary embodiment. This can be the operating device 100 described in reference to FIG. 8. The surface 110 is deformed, according to this exemplary embodiment, such that the operating element 120 forms a square with four square sections 900 when viewed from above. A visible base of the square forms the touch-sensitive region according to this exemplary embodiment. Each of the square sections 900 has a display section 305 facing away from the middle of the square and facing a respective outer edge of the square, which is configured to display a gear setting, P, R, N, D dedicated to the square section 900. The sensor described in reference to FIG. 1, each of which is dedicated to one of the gear settings, P, R, N, D, are each located in the regions of the four display sections 305 according to this exemplary embodiment. The sensor described in reference to FIG. 4 has at least four sensor elements according to this exemplary embodiment, each of which is dedicated to one of the gear settings, P, R, N, D. The sensor elements are each located in the regions of the four display sections 305 according to this exemplary embodiment.

FIG. 10 shows a schematic cross sectional illustration of an operating device 100 according to an exemplary embodiment. This can be the operating device 100 described in reference to FIG. 7, with the difference that the operating device 100 contains a pneumatic actuator 1000 instead of the electromechanical actuator. The pneumatic actuator 1000 has an air intake 1005 and an air discharge 1010.

FIG. 11 shows a schematic cross sectional illustration of an operating device 100 according to an exemplary embodiment. This can be the operating device 100 described in reference to FIG. 10, with the difference that the deformable surface 110 according to this exemplary embodiment is in the deformed state 115, in which the operating element 120 according to this exemplary embodiment forms a haptic finger track 1100. For this, a central subsection of the surface 110 is moved upward by the pneumatic actuator 1000. The pneumatic actuator 1000 generates the haptic operating element 120 using pressurized air.

FIG. 12 shows a schematic top view of an operating device 100 according to an exemplary embodiment. This can be the operating device 100 described in reference to FIG. 11. The operating element 120 has a circular shape when seen from above according to this exemplary embodiment.

A surface of the circular operating element 120 that is visible therein forms the touch-sensitive region according to this exemplary embodiment. There are five adjacent display sections 305 formed on the edge of the circular operating element 120, which display the respective gear settings P, R, N, D, S to which they are dedicated.

The sensor described in reference to FIG. 4 has at least five sensor elements according to this exemplary embodiment, each of which are dedicated to a gear setting, P, R, N, D, S. The sensor elements according to this exemplary embodiment are each located in the regions of the five display sections 305.

The exemplary embodiments described in reference to, and shown in the figures are selected merely by way of example. Different exemplary embodiments can be combined with one another, either entirely or with respect to individual features. Furthermore, one exemplary embodiment can be supplemented by features of another exemplary embodiment.

FIG. 13 shows a flow chart for a method 1300 for selecting at least one gear setting of a vehicle according to an exemplary embodiment. The method 1300 comprises at least one input step 1305 and one output step 1310. In the input step 1305, a touch signal is input that represents the touching of the touch-sensitive region of the haptic operating element. In the output step 1310, a transmission signal is output in order to set the gear setting based on the touch signal.

The steps presented herein can be repeated and executed in a sequence other than that described above.

If an exemplary embodiment comprises an “and/or” conjunction between a first feature and a second feature, this can be read to mean that the exemplary embodiment according to one embodiment contains both the first feature and the second feature, and according to another embodiment, contains either just the first feature, or just the second feature.

### REFERENCE SYMBOLS

| | |
|---|---|
| 100 | operating device |
| 105 | sensor |
| 110 | surface |
| 115 | deformed state |
| 120 | operating element |
| 130 | actuator |
| 200 | un-deformed state |
| 300 | finger track |
| 302 | middle |
| 305 | display section |
| 400 | electromagnetic actuator |
| 405 | molded support |
| 600 | other operating element |
| 605 | arrow shaft |
| 700 | electromechanical actuator |
| 900 | square section |
| 1000 | pneumatic actuator |
| 1005 | air intake |
| 1010 | air discharge |
| 1100 | finger track |

1. An operating device for selecting at least one gear setting of a vehicle, wherein the operating device has at least one sensor with a touch-sensitive region, and a deformable surface, which is configured to form a haptic operating element with the at least one sensor in a deformed state, which is configured to output a selection signal for selecting the gear setting in response to touching the touch-sensitive region.

2. The operating device according to claim 1, which has at least one actuator that is configured to convert the surface to the deformed state.

3. The operating device according to claim 1, in which a material of the surface at least partially exhibits a polygonal and/or hexagonal structure.

4. The operating device according to claim 1, in which the surface forms at least one finger track in the deformed state.

5. The operating device according to claim 1, wherein the actuator contains at least a magnetorheological elastomer, and/or an electromagnetic actuator, and/or a pneumatic actuator, and/or an electromechanical actuator.

6. The operating device according to claim 1, in which the touch-sensitive region of the sensor contains at least one display section, which is configured to display at least the gear setting.

7. The operating device according to claim 1, in which the display section has at least an LCD/TFT display, and/or an OLED display, and/or an RP* polycarbonate film.

8. The operating device according to claim 1, in which the surface is made at least in part of at least an elastomer, and/or wood, and/or metal, and/or rock, and/or synthetic material, and/or leather.

9. The operating device according to claim 1, in which at least a sub-region of the touch-sensitive region of the sensor is configured to generate a haptic feedback in response to touch.

10. The operating device according to claim 1, which is located in the armrest, and/or hand rest, and/or a central console, and/or a steering wheel, and/or a dashboard of the vehicle.

11. The operating device according to claim 1, which is configured to convert the surface to the deformed state in response to a starting of the vehicle, and/or a proximity signal of a proximity sensor system of the vehicle, when the operating device is located in the vehicle.

12. A vehicle that has an operating device according to claim 1.

13. A method for operating an operating device according to claim 1, wherein the method comprises at least the following steps:
inputting a touch signal that represents the touching of the touch-sensitive region of the sensor of the haptic operating element; and
outputting a transmission signal that is configured to set the gear setting on the basis of the touch signal.

14. The operating device according to claim 2, in which a material of the surface at least partially exhibits a polygonal and/or hexagonal structure.

15. The operating device according to claim 2, in which the surface forms at least one finger track in the deformed state.

16. The operating device according to claim 2, wherein the actuator contains at least a magnetorheological elastomer, and/or an electromagnetic actuator, and/or a pneumatic actuator, and/or an electromechanical actuator.

17. The operating device according to claim 2, in which the touch-sensitive region of the sensor contains at least one display section, which is configured to display at least the gear setting.

18. The operating device according to claim 2, in which the display section has at least an LCD/TFT display, and/or an OLED display, and/or an RP* polycarbonate film.

19. The operating device according to claim 2, in which the surface is made at least in part of at least an elastomer, and/or wood, and/or metal, and/or rock, and/or synthetic material, and/or leather.

20. The operating device according to claim 2, in which at least a sub-region of the touch-sensitive region of the sensor is configured to generate a haptic feedback in response to touch.
